(19) United States
(12) Patent Application Publication
(10) Pub. No.: US 2007/0195271 A1
(43) Pub. Date: Aug. 23, 2007

(54) Projection system with scanning device

(75) Inventors: Siebe Tjerk De Zwart, Eindhoven (NL); Oscar Hendrikus Willemsen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,358

(22) PCT Filed: Mar. 22, 2005
(86) PCT No.: PCT/IB05/50970

§ 371 Date: Sep. 26, 2006

(30) Foreign Application Priority Data
Mar. 31, 2004 (EP) 04101322.8

(51) Int. Cl. G03B 21/14

(52) U.S. Cl. 353/20

(57) ABSTRACT

A projection system is described for displaying image information, comprising an illumination system for generating a light beam, a scanning device comprising a mirror for scanning the generated light beam to form an image on a screen, and a scan angle enlarger cooperating with the scanning device for enlarging a scan angle of the generated light beam. The scan angle enlarger comprises a reflective polarizer, a quarter-wave plate and a mirror arranged to reflect the light beam at least once between the reflective polarizer and the mirror via the quarter-wave plate. This arrangement allows a compact assembly of the projection system for use in small portable devices such as mobile phones and PDAs.

The invention relates to a projection system for displaying image information, comprising an illumination system for generating a polarized light beam, a scanning device for scanning the polarized light beam to form an image on a screen and a scan angle enlarger cooperating with the scanning device for enlarging a scan angle of the polarized light beam.

Such a projection system can be built in a compact way and is therefore usable in small portable electronic equipment such as mobile phones, personal digital assistants (PDAs) and electronic gaming devices.

Such a projection system is known from U.S. Pat. No. 5,751,464. The known projection system can be used for displaying all kinds of information, such as data, video and still pictures. The known device comprises a semiconductor laser, a cylindrical lens having a refracting power in a sub-scanning direction, a reflecting mirror serving as a first image-forming system, a polygon mirror rotatable about a center axis serving as an optical deflector, and a first and a second curved mirror serving as a second image-forming system. In operation, the cylindrical lens converges the laser beam in the sub-scanning direction and focuses the laser beam on the reflecting surface of the polygon mirror as a line image. Due to the rotation of the mirror about the center of the axis of rotation, the polygon mirror in combination with the first and the second curved mirror scans and focuses an image on the surface of a screen.

The known projection system has the drawback that the fixed mirrors require a complicated curved shape and a relatively large area to operate.

It is an object of the invention to provide a projection system which can be assembled in a relatively easy way and has compact dimensions allowing use in small mobile equipment. In order to achieve this object, the invention provides a projection system as specified in claim 1.

The invention is based on, inter alia, the recognition that in this arrangement the scan angle of the light beam can be enlarged by utilizing the combination of reflections, conversions of the polarization of the reflected light beam and selective transmission of the light beams. The selective reflection of the reflective polarizer allows application of plane, unstructured, optical reflectors and a compact way of positioning the mirrors for enlargement of the scan angle. In operation, the reflective polarizer transmits only a linearly polarized light beam with a polarization in a first predetermined direction. The quarter-wave plate converts the linearly polarized light from the reflective polarizer into, for example, a laevorotatory circularly polarized light beam and reflects the circularly polarized light beam to the reflective polarizer via the quarter-wave plate. On reflection, the mirror converts the laevorotatory circular polarization of the light beam into a dextrorotatory circular polarization. The quarter-wave plate converts the dextrorotatory circular polarization of the reflected light beam into a linear polarization in the second direction. The reflective polarizer reflects this light beam back to the mirror via the quarter-wave plate. The quarter-wave plate converts the linearly polarized light beam with the direction of polarization in the second direction into a light beam with a dextrorotatory circular polarization. The mirror again reflects the circularly polarized light beam to the reflective polarizer via the quarter-wave plate and, upon reflection, converts the dextrorotatory circular polarization into a laevorotatory circular polarization. The quarter-wave plate converts the laevorotatory circular polarization of the reflected light beam into a linear direction of polarization in the first direction. The reflective polarizer transmits this linearly polarized light beam to a screen. As a result of passing the mirror twice, the light beam leaves the projection system at an angle that equals two times the predetermined angle between the orientation of the mirror and the orientation of both the reflective polarizer and the quarter-wave plate. In this arrangement, the quarter-wave plate and the reflective polarizer can be positioned close to the mirror area. Furthermore, the mirror area may be slightly larger than the mirror area needed for a mirror for single reflection. Consequently, this projection system can be assembled in a relatively easy way in compact dimensions for incorporating it in small portable, electronic devices.

A further embodiment is specified in claim 2. In this arrangement, the reflective polarizer is divided into two portions allowing further reflections of the light beam between the respective portion of the reflective polarizer and the mirror for further enlargement of the scan angle.

A further embodiment is specified in claim 3. By adding one or more third portions in the reflective polarizer, the number of reflections of the light beam between the mirror and the reflective polarizer is further increased for further enlargement of the scan angle.

A further embodiment is specified in claim 4. For a maximal contrast, the fast axis of the quarter-wave plate can be positioned at an angle of 45° to the axis of polarization of the reflective polarizer.

A further embodiment is specified in claim 5. Inclination of the mirror with respect to the reflective polarizer and the quarter-wave plate causes the different order reflections of the light beam to leave the system in different directions.

A further embodiment is specified in claim 6. The angular beam separator filters out zero order and reflections of the light beam having an order of more than two. In this arrangement, only the second-order reflection of the light beam is used for image formation. The angular beam separator has a rectangular slit. Alternatively, this angular filter may be formed by a cylindrical lens and a diaphragm.

In a further embodiment, the mirror, the quarter-wave plate and the reflective polarizer are provided with flat, unstructured, surfaces.

In a further embodiment, the quarter-wave plate and the reflective polarizer are integrated in a single optical component.

A further embodiment is specified in claim 12. A semiconductor laser generates a linearly polarized light beam and can be effectively used in this projection system.

These and other aspects of the invention are apparent from and will be elucidated with reference to the embodiments described hereinafter.

In the drawings:

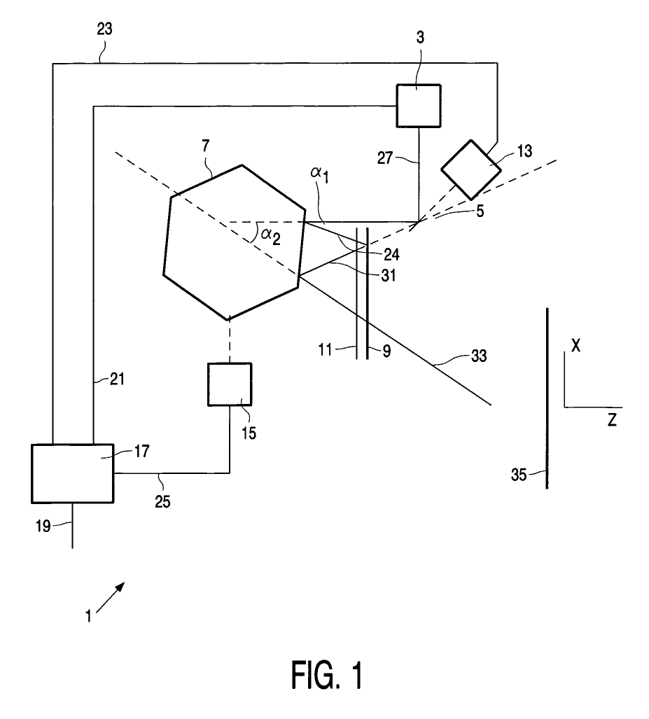

FIG. 1 shows diagrammatically a first embodiment of a projection system,

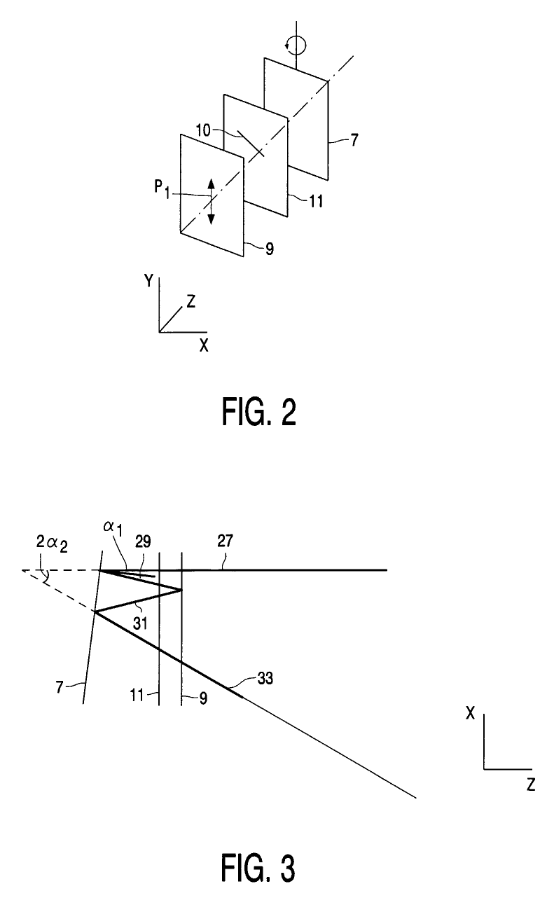

FIG. 2 shows details of the first embodiment of a scanning mirror, a quarter-wave plate and a reflecting polarizer,

FIG. 3 shows the orientation of the quarter-wave plate and the reflective polarizer,

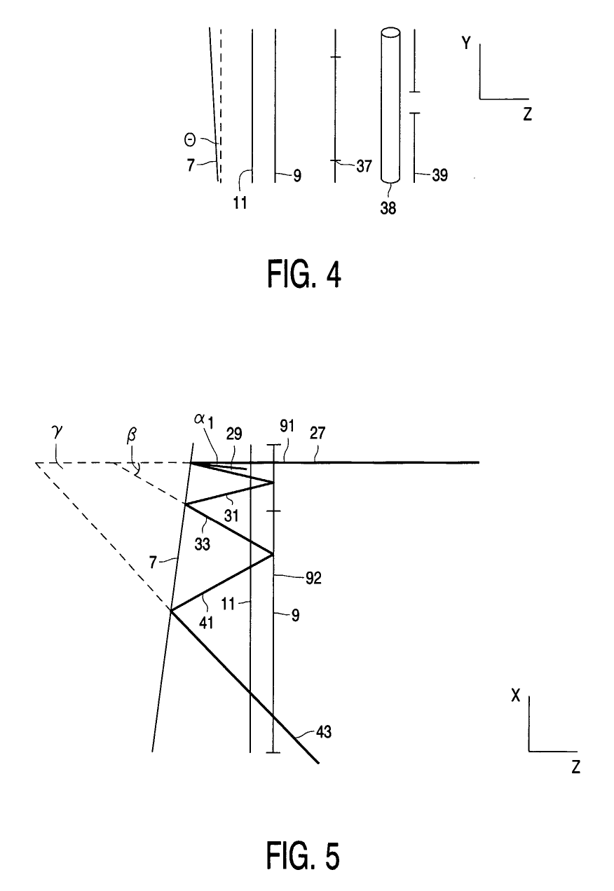

FIG. 4 shows the inclination of the scanning mirror with respect to the quarter-wave plate and the reflecting polarizer,

FIG. 5 shows a second embodiment of a scanning mirror, a quarter-wave plate and a reflecting polarizer comprising two portions with different axes of polarization, and

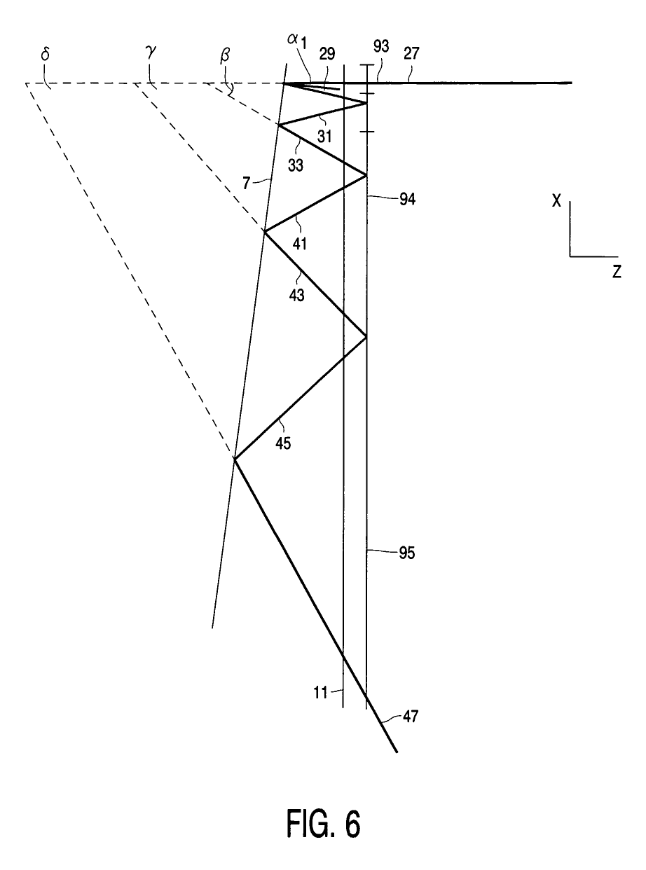

FIG. 6 shows a third embodiment of a scanning mirror, a quarter-wave plate and a reflecting polarizer comprising three different portions.

FIG. 1 shows a first embodiment of a projection system 1 for displaying image information. The projection system 1 comprises an illumination system, for example, a semiconductor laser 3 having a wavelength of 628 nm for generating a linearly polarized light beam with a first direction of polarization. In operation, the semiconductor laser 3 may be driven by a data signal 21 for modulating the light beam. Furthermore, the projection system 1 comprises a scanning device formed by a first movable mirror 5 and an actuator 13 for scanning the light beam in the first or slow direction of the projected image. The first movable mirror 5 may comprise a galvonometer actuator 13, a piezo-actuator or other types of vibrating actuators. In this example, this first, slow direction is parallel to the Y-axis, perpendicular to the plane of the drawing.

Instead of the first movable mirror 5 and the actuator 13, a linear laser array can be applied alternatively, which laser array comprises, for example, 128 laser sources on a line which is directed parallel to the Y-axis.

The scanning device further comprises a second rotatable mirror 7 and a drive motor 15 connected via a shaft to the second rotatable mirror 7 for scanning the modulated light beam in the second or fast direction parallel to the X-axis to form an image on a screen 35. The second rotatable mirror 7 can be formed by a reflecting surface of a rotatable hexagon connected via the shaft to the drive motor 15. Furthermore, the projection system 1 comprises a scan angle enlarger formed by a quarter-wave plate 11 and a reflective polarizer 9 cooperating with the second rotatable mirror 7 for enlarging the scan angle of the polarized light beam. The direction of polarization of the reflective polarizer is parallel to the first direction of polarization of the incoming light beam 27. The reflective polarizer 9 can be formed from a DBEF foil as can be obtained from 3M. Alternatively, a wire grid polarizer can be applied as a reflective polarizer. Wire grid polarizers are known per se and can be obtained from Moxtek.

Furthermore, it is possible to reverse the order in which the light beam passes the first mirror for scanning the light beam in the slow scanning direction and the second mirror for scanning the light beam in the fast scanning direction.

FIG. 2 shows the orientation of the fast axis 10 of the quarter-wave plate 11 with respect to the axis of polarization P1 of the reflective polarizer 9 and the second rotatable mirror 7. For optimal contrast, the fast axis 10 of the quarter-wave plate 11 may be directed at an angle of 45° to the axis of polarization P1 of the reflective polarizer 9.

Furthermore, the projection system 1 comprises a data-processing and synchronizing device 17. In operation, the data-processing and synchronizing device generates drive signals 23, 25 which are sent to the actuator 13 of the first movable scanning mirror 5 and the drive motor 15 of the second rotatable mirror 7, respectively. Furthermore, the data-processing and synchronizing device generates a data signal 21 for modulating the semiconductor laser 3 depending on the incoming video or data graphics signal 19 and synchronizes the scanning movements of the second rotatable mirror 7 and the movable mirror 5 with the incoming video signal or data graphics signal 19 in order to project an image on the screen 35.

FIG. 3 shows a detailed picture of the reflected and transmitted light beams between the second rotatable mirror 7 and the reflective polarizer 9 via the quarter-wave plate 11. The plane of the reflective polarizer 9 is directed at an angle α1 to the second rotatable mirror 7. In operation, an incoming linearly polarized light beam 27 from the semiconductor laser 3 is incident on the second rotatable mirror 7 at an angle α1 to the normal on the surface of the second rotatable mirror 7 via the reflective polarizer 9 and the quarter-wave plate 11. The polarization of the incoming light beam is directed in a first direction. The reflective polarizer 9, oriented with its axis of polarization P1 parallel to the first direction of polarization, transmits the polarized light beam 27 to the second rotatable mirror 7. The quarter-wave plate 11 converts the linear polarization of the light beam 27 into a circular polarization, for example, in a laevorotatory sense. The second rotatable mirror 7 converts the laevorotatory circular polarization of the first light beam into a dextrorotatory circular polarization and reflects the light beam 29 to the reflective polarizer 9 via the quarter-wave plate 11. The quarter-wave plate 11 converts the dextrorotatory circular polarization of the reflected light beam 29 into a linearly polarized light beam with a second direction of polarization perpendicular to the first direction of polarization. The reflective polarizer 9 with its axis of polarization 10 perpendicular to the second direction of polarization of the light beam 29 reflects this light beam 31 back to the second rotatable mirror 7 via the quarter-wave plate 11. The quarter-wave plate 11 converts the linearly polarized light beam 31 with the second direction of polarization into a circularly polarized light beam with a dextrorotatory circular polarization. The second rotatable mirror 7 converts the dextrorotatory circular polarization into a laevorotatory circular polarization and reflects the circularly polarized light beam 33 to the reflective polarizer 9 via the quarter-wave plate 11. The quarter-wave plate 11 converts the laevorotatory circular polarization of the reflected light beam into a linearly polarized light beam with the first direction of polarization. The reflective polarizer 9 with its axis of polarization parallel to the direction of polarization of the reflected light beam 33 transmits this reflected light beam as a departing light beam 33 to the screen 35. The angle α2 of this departing light beam with respect to the incoming light beam 27 is 4α1. In this arrangement, the scan angle is doubled with respect to the angle 2α1 as may be obtained in a conventional projection system with scanning mirrors but without a scan angle enlarger comprising the reflective polarizer 9 and the quarter-wave plate 11.

In a further embodiment, the quarter-wave plate 11 can be integrated with the reflective polarizer 9 by providing a phase-retarding layer on the reflective polarizer. Furthermore, the rotatable mirror 7 and the reflective polarizer 9 may have flat surfaces. In this embodiment, the quarter-wave plate 11 and the reflective polarizer 9 can be positioned close to the rotatable mirror 7 and hence the area of the rotatable mirror 7 may be nearly equal to that for conventional usage having only a single reflection, and a compact projection system can be obtained. The orientation of the second rotatable mirror 7, the quarter-wave plate 11 and the reflective polarizer 9 may be parallel to the YX-plane.

FIG. 4 shows an arrangement of the rotatable mirror 7, the quarter-wave plate 11, the reflective polarizer 9 and an angular beam separator. The angular beam separator is formed by the inclination of the rotatable mirror 7 with respect to the YX-plane, while the quarter-wave plate 11 and the reflective polarizer 9 remain directed parallel to the YX-plane. Furthermore, a rectangular aperture or slit 37 is positioned between the reflective polarizer 9 and the screen 35. The longitudinal direction of the slit is directed parallel to the X-axis. As a result of the vertical inclination of the rotatable mirror 7 with respect to the reflective polarizer 9, the different passages of the reflected light beam emerge at different angles and can be filtered out by the slit 37. This angular beam separator reduces a zero-order passage, a 1^{st} passage, a 3^{rd} passage and higher passages of the light beam due to imperfections of the quarter-wave plate 11 and the reflective polarizer 9. Furthermore, instead of a rectangular slit, a cylindrical lens 38 and a diaphragm 39 can be applied for transmitting only the desired reflection of the light beam. The axis of the cylindrical lens is directed parallel to the Y-axis.

FIG. 5 shows a further embodiment of the scan angle enlarger of the projection system. This embodiment comprises a reflective polarizer 9, a quarter-wave plate 11 and the second rotatable mirror 7. In this embodiment, the reflective polarizer 9 comprises a rectangular first portion 91 and a rectangular second portion 92 wherein the direction of polarization of the first portion 91 is parallel to the direction of polarization of the incoming linearly polarized light beam 27 from the rotatable mirror 7. Furthermore, the direction of polarization of the second portion 92 is parallel to the direction of polarization of the departing light beam, wherein the axis of polarization of the first and second portions 91, 92 are mutually perpendicular.

In operation, an incoming linearly polarized light beam 21 from the semiconductor laser 3 is incident on the second rotatable mirror 7 at an angle α1 to the normal on the surface of the second rotatable mirror 7 via the first portion 91 of the reflective polarizer 9 and the quarter-wave plate 11. The polarization of the incoming light beam is directed in the first direction. The first portion 91 of reflective polarizer 9, oriented with its axis of polarization parallel to the first direction of polarization of the incoming linearly polarized light beam 27, transmits the linearly polarized light beam 27. The quarter-wave plate 11 converts the linear polarization of the light beam 27 into a circular polarization, for example, in a laevorotatory sense. The second rotatable mirror 7 converts the laevorotatory circular polarization of the first light beam into a dextrorotatory circular polarization and reflects the light beam 29 to the first portion 91 of the reflective polarizer 9 via the quarter-wave plate 11. The quarter-wave plate 11 converts the dextrorotatory circular polarization of the reflected light beam 29 into a linearly polarized light beam with a second direction of polarization perpendicular to the first direction of polarization. The first portion 91 of the reflective polarizer 9 with is axis of polarization perpendicular to the second direction of polarization of the light beam 29 reflects this light beam 31 back to the second rotatable mirror 7 via the quarter-wave plate 11. The quarter-wave plate 11 converts the linearly polarized light beam 31 with the second direction of polarization into a circularly polarized light beam in a dextrorotatory sense. The second rotatable mirror 7 converts the dextrorotatory circular polarization into a laevorotatory circular polarization and reflects the circularly polarized light beam 33 to the second portion 92 of the reflective polarizer 9 via the quarter-wave plate 11. The quarter-wave plate 11 converts the laevorotatory circular polarization of the reflected light beam into a linear polarization directed in the first direction of polarization. The second portion 92 of the reflective polarizer 9 with its axis of polarization perpendicular to the first direction of polarization of the light beam 33 reflects this light beam back to the second rotatable mirror 7 via the quarter-wave plate 11. The quarter-wave plate 11 converts the linearly polarized light beam 31 with the second direction of polarization into a circularly polarized light beam with a laevorotatory circular polarization. The second rotatable mirror 7 converts the laevorotatory circular polarization into a dextrorotatory circular polarization and reflects the circularly polarized light beam 33 to the second portion 92 of the reflective polarizer 9 via the quarter-wave plate 11. The quarter-wave plate 11 converts the dextrorotatory circular polarization of the reflected light beam into a linear polarization directed in the second direction of polarization. The second portion 92 of the reflective polarizer 9 with its axis of polarization parallel to the second direction of polarization transmits the light beam as a departing light beam 43. In this arrangement, the scan angle is multiplied 3 times with respect to the scan angle 2α1.

A greater enlargement of the scan angle can be obtained in an embodiment wherein the reflective polarizer comprises one or more third portions of the reflective polarizer between the first and second portions. In this embodiment, the third portions are 10 arranged in such a way that the axes of polarization of the respective portions receiving the reflected light beams from the rotatable mirror are directed perpendicular to the direction of polarization of the respective reflected light beams.

FIG. 6 shows a further embodiment of the scan angle enlarger of a projection system comprising a reflective polarizer 9, a quarter-wave plate 11 and the second rotatable mirror 7. In this embodiment, the reflective polarizer 9 comprises two rectangular first and second portions 93, 95, wherein the direction of polarization of the first portion 93 is parallel to the direction of polarization of an incoming linearly polarized light beam 27 from the mirror 5. The direction of polarization of the second portion 95 coincides with the direction of polarization of the departing linearly polarized light beam. Furthermore, the reflective polarizer 9 comprises a third rectangular portion 94 between the first and the second portion 93, 95. The axis of polarization of the third portion 95 is perpendicular to the direction of polarization of the linearly polarized light beam 43 reflected a third time from the second rotatable mirror 7.

The operation of this embodiment is similar to that of the embodiment described with reference to FIG. 5, except that after the linearly polarized light beam has been reflected a third time from the second rotatable mirror 7, the third portion 95 reflects the linearly polarized light beam back to the second rotatable mirror 7 via the quarter-wave plate 11, because the axis of polarization of the reflective polarizer is perpendicular to the direction of polarization of the light beam 43. The quarter-wave plate 11 converts the linear polarization of the light beam 45 into a dextrorotatory circular polarization. The second rotatable mirror 7 converts the dextrorotatory circular polarization into a laevorotatory polarization and reflects the circularly polarized light beam to the third portion 95 of the reflective polarizer 9 via the quarter-wave plate 11. The quarter-wave plate 11 converts the laevorotatory polarization of the reflected light beam into a linear polarization directed in the second direction. The direction of polarization of the second portion 95 of the reflective polarizer 9 is parallel to the second direction of polarization of the reflected linearly polarized light beam and transmits the light beam as departing light beam 47. In this arrangement, the scan angle δ is multiplied 4 times with respect to the scan angle 2α.

In this embodiment, the quarter-wave plate may be integrated with the second rotatable mirror so as to allow image projection with a finite cross-section of the light beam.

In summary, a projection system is disclosed for displaying image information, comprising an illumination system for generating a light beam, a scanning device comprising a mirror for scanning the generated light beam to form an image on a screen, and a scan angle enlarger cooperating with the scanning device for enlarging a scan angle of the generated light beam. The scan angle enlarger comprises a reflective polarizer, a quarter-wave plate and a mirror arranged to reflect the light beam at least once between the reflective polarizer and the mirror via the quarter-wave plate. This arrangement allows a compact assembly of the projection system for use in small portable devices such as mobile phones and PDAs.

It will be obvious that many variations are possible within the scope of the invention without departing from the scope of the appended claims.

1. A projection system (1) for displaying image information, comprising:
an illumination system (3) for generating a light beam,
a scanning device (5,13,7,15) comprising a mirror (5,7) for scanning the light beam to form an image on a screen (35), and
a scan angle enlarger (7,9) cooperating with the scanning device for enlarging a scan angle of the polarized light beam,
characterized in that the scan angle enlarger comprises a reflective polarizer (9), a quarter-wave plate (11) and a mirror (7) arranged to reflect the light beam at least once between the reflective polarizer (9) and the mirror (7) via the quarter-wave plate.

2. A projection system as claimed in claim 1, wherein the reflective polarizer (9) comprises a first portion (91) and a second portion (92), wherein the axis of polarization of the first portion is perpendicular to the axis of polarization of the second portion.

3. A projection system as claimed in claim 2, wherein the reflective polarizer (9) comprises one or more third portions (94) positioned between the first and the second portion (93, 95), wherein the axis of polarization of the one or more portions is perpendicular to a direction of polarization of one or more respective reflected light beams received by the respective one or more third portions from the mirror (7).

4. A projection system as claimed in claim 1, wherein the orientation of the fast axis of the quarter-wave plate (10) is directed at an angle of 45° to the axis of polarization (P1) of the reflective polarizer (9).

5. A projection system as claimed in claim 1, wherein the orientation of the reflective polarizer (9) and the orientation of the quarter-wave plate (11) are directed in a first plane parallel to the first and the second axis, the second axis being perpendicular to the first axis, and wherein the orientation of the mirror (7) is directed in a second plane parallel to the first axis and at a predetermined angle of inclination θ to the second axis for directing higher-order reflections of the light beam in different directions from the mirror.

6. A projection system as claimed in claim 1, wherein the projection system is provided with an angular beam separator positioned between the reflective polarizer (9) and the screen (35) for transmitting a predetermined order of reflection of the light beam.

7. A projection system as claimed in claim 6, wherein the angular beam separator is provided with a rectangular aperture having its long axis directed parallel to the first axis.

8. A projection system as claimed in claim 6, wherein the angular beam separator comprises a cylindrical lens and a diaphragm.

9. A projection system as claimed in claim 1, wherein the mirror (7), the quarter-wave plate (11) and the reflective polarizer (9) are flat, unstructured, optical elements.

10. A projection system as claimed in claim 1, wherein the quarter-wave plate (11) and the reflective polarizer (9) are integrated in a single optical element.

11. A projection system as claimed in claim 1, wherein the illumination system (3) comprises a semiconductor laser for generating a linearly polarized light beam.

12. A projection system as claimed in claim 1, wherein the mirror (7) is formed by a reflecting surface of a rotatable hexagon.

13. A projection system as claimed in claim 1, wherein the projection system comprises a modulating device (17) for modulating the polarized light beam.
